(19) United States
(12) Patent Application Publication
(10) Pub. No.: US 2013/0228529 A1
(43) Pub. Date: Sep. 5, 2013

(54) MICROPOROUS MATERIAL HAVING FILTRATION AND ADSORPTION PROPERTIES AND THEIR USE IN FLUID PURIFICATION PROCESSES

(71) Applicants: Qunhui Guo, Murrysville, PA (US); Carol L. Knox, Apollo, PA (US); Raphael O. Kollah, Wexford, PA (US); Justin J. Martin, Jeannette, PA (US); Timothy A. Okel, Trafford, PA (US); Daniel E. Rardon, Pittsburgh, PA (US); Christine Gardner, Irwin, PA (US); Shantilal M. Mohnot, Murrysville, PA (US)

(72) Inventors: Qunhui Guo, Murrysville, PA (US); Carol L. Knox, Apollo, PA (US); Raphael O. Kollah, Wexford, PA (US); Justin J. Martin, Jeannette, PA (US); Timothy A. Okel, Trafford, PA (US); Daniel E. Rardon, Pittsburgh, PA (US); Christine Gardner, Irwin, PA (US); Shantilal M. Mohnot, Murrysville, PA (US)

(73) Assignee: PPG Industries Ohio, Inc., Cleveland, OH (US)

(21) Appl. No.: 13/599,221

(22) Filed: Aug. 30, 2012

Related U.S. Application Data
(60) Provisional application No. 61/555,500, filed on Nov. 4, 2011.

(51) Int. Cl. B01D 71/26; B01D 61/14; B01D 53/22; B01D 67/00

(52) U.S. Cl. CPC B01D 71/26; B01D 67/0086; B01D 61/147; B01D 53/228
USPC 210/767; 264/48; 210/500.36; 210/490; 95/45; 96/12; 96/4

(57) ABSTRACT

The present invention is directed to microfiltration membranes comprising a microporous material, said microporous material comprising:
(a) a polyolefin matrix present in an amount of at least 2 percent by weight,
(b) finely divided, particulate, substantially water-insoluble silica filler distributed throughout said matrix, said filler constituting from about 10 percent to about 90 percent by weight of said microporous material substrate, wherein the weight ratio of filler to polyolefin is greater than 4:1; and
(c) at least 35 percent by volume of a network of interconnecting pores communicating throughout the microporous material.

The present invention is also directed to methods of separating suspended or dissolved materials from a fluid stream such as a liquid or gaseous stream, comprising passing the fluid stream through the microfiltration membrane described above.

### CROSS REFERENCE TO RELATED APPLICATIONS

This application claims the benefit of U.S. Provisional Patent Application No. 61/555,500, filed on Nov. 4, 2011.

### STATEMENT REGARDING FEDERALLY SPONSORED RESEARCH AND DEVELOPMENT

This invention was made with Government support under Contract No. W9132T-09-C-0046 awarded by the Engineer Research Development Center-Construction Engineering Research Laboratory (“ERDC-CERL”). The United States Government may have certain rights in this invention.

### FIELD OF THE INVENTION

The present invention relates to microporous materials useful in filtration and adsorption membranes and their use in fluid purification processes.

### BACKGROUND OF THE INVENTION

Accessibility to clean and potable water is a concern throughout the world, particularly in developing countries. The search for low-cost, effective filtration materials and processes is ongoing. Filtration media that can remove both macroscopic, particulate contaminants and molecular contaminants are particularly desired, including those that can remove both hydrophilic and hydrophobic contaminants at low cost and high flux rate.

It would be desirable to provide novel membranes suitable for use on liquid or gaseous streams that serve to remove contaminants via both chemisorption and physisorption.

### SUMMARY OF THE INVENTION

The present invention is directed to microfiltration membranes comprising a microporous material, said microporous material comprising:

(a) a polyolefin matrix present in an amount of at least 2 percent by weight,

(b) finely divided, particulate, substantially water-insoluble silica filler distributed throughout said matrix, said filler constituting from about 10 percent to about 90 percent by weight of said microporous material substrate, wherein the weight ratio of filler to polyolefin is greater than 4:1; and

(c) at least 35 percent by volume of a network of interconnecting pores communicating throughout the microporous material; wherein said microporous material is prepared by the following steps:
(i) mixing the polyolefin matrix (a), silica (b), and a processing plasticizer until a substantially uniform mixture is obtained;
(ii) introducing the mixture, optionally with additional processing plasticizer, into a heated barrel of a screw extruder and extruding the mixture through a sheeting die to form a continuous sheet;
(iii) forwarding the continuous sheet formed by the die to a pair of heated calender rolls acting cooperatively to form continuous sheet of lesser thickness than the continuous sheet exiting from the die;
(iv) stretching the continuous sheet in at least one stretching direction above the elastic limit, wherein the stretching occurs during or immediately after step (ii) and/or step (iii) but prior to step (v);
(v) passing the stretched sheet to a first extraction zone where the processing plasticizer is substantially removed by extraction with an organic liquid;
(vi) passing the continuous sheet to a second extraction zone where residual organic extraction liquid is substantially removed by steam and/or water;
(vii) passing the continuous sheet through a dryer for substantial removal of residual water and remaining residual organic extraction liquid; and
(viii) optionally stretching the continuous sheet in at least one stretching direction above the elastic limit, wherein the stretching occurs during or immediately after step (v), step (vi), and/or step (vii); to form a microporous material.

The present invention is also directed to methods of separating suspended or dissolved materials from a fluid stream such as a liquid or gaseous stream, comprising passing the fluid stream through the microfiltration membrane described above.

The desired product resulting from the separation process may be the purified filtrate, such as in the case of removing contaminants from a waste stream, or the concentrated feed for recirculation through a system, such as in the reconstituting of an electrodeposition bath.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various embodiments and examples of the present invention as presented herein are each understood to be non-limiting with respect to the scope of the invention.

As used in the following description and claims, the following terms have the meanings indicated below:

By “polymer” is meant a polymer including homopolymers and copolymers, and oligomers. By “composite material” is meant a combination of two or more differing materials.

As used herein, “formed from” denotes open, e.g., “comprising,” claim language. As such, it is intended that a composition “formed from” a list of recited components be a composition comprising at least these recited components, and can further comprise other, nonrecited components, during the composition's formation.

As used herein, the term “polymeric inorganic material” means a polymeric material having a backbone repeat unit based on an element or elements other than carbon. For more information see James Mark et al., Inorganic Polymers, Prentice Hall Polymer Science and Engineering Series, (1992) at page 5, which is specifically incorporated by reference herein. Moreover, as used herein, the term “polymeric organic materials” means synthetic polymeric materials, semisynthetic polymeric materials and natural polymeric materials, all of which have a backbone repeat unit based on carbon.

An “organic material,” as used herein, means carbon containing compounds wherein the carbon is typically bonded to itself and to hydrogen, and often to other elements as well, and excludes binary compounds such as the carbon oxides, the carbides, carbon disulfide, etc.; such ternary compounds as the metallic cyanides, metallic carbonyls, phosgene, carbonyl sulfide, etc.; and carbon-containing ionic compounds such as metallic carbonates, for example calcium carbonate and sodium carbonate. See R. Lewis, Sr., Hawley's Condensed Chemical Dictionary, (12th Ed. 1993) at pages 761-762, and M. Silberberg, Chemistry The Molecular Nature of Matter and Change (1996) at page 586, which are specifically incorporated by reference herein.

As used herein, the term “inorganic material” means any material that is not an organic material.

As used herein, a “thermopiastic” material is a material that softens when exposed to heat and returns to its original condition when cooled to room temperature. As used herein, a “thermoset” material is a material that solidifies or “sets” irreversibly when heated.

As used herein, “microporous material” or “microporous sheet material” means a material having a network of interconnecting pores, wherein, on a coating-free, printing ink-free, impregnant-free, and pre-bonding basis, the pores have a volume average diameter ranging from 0.001 to 0.5 micrometer, and constitute at least 5 percent by volume of the material as discussed herein below.

By “plastomer” is meant a polymer exhibiting both plastic and elastomeric properties.

As noted above, the present invention is directed to microfiltration membranes comprising a microporous material, said microporous material comprising:

(a) a polyolefin matrix present in an amount of at least 2 percent by weight,

(b) finely divided, particulate, substantially water-insoluble silica filler distributed throughout said matrix, said filler constituting from about 10 percent to about 90 percent by weight of said microporous material substrate, wherein the weight ratio of filler to polyolefin is greater than 4:1; and

(c) at least 35 percent by volume of a network of interconnecting pores communicating throughout the microporous material; wherein said microporous material is prepared by the following steps:
(i) mixing the polyolefin matrix (a), silica (b), and a processing plasticizer until a substantially uniform mixture is obtained;
(ii) introducing the mixture, optionally with additional processing plasticizer, into a heated barrel of a screw extruder and extruding the mixture through a sheeting die to form a continuous sheet;
(iii) forwarding the continuous sheet formed by the die to a pair of heated calender rolls acting cooperatively to form continuous sheet of lesser thickness than the continuous sheet exiting from the die;
(iv) stretching the continuous sheet in at least one stretching direction above the elastic limit, wherein the stretching occurs during or immediately after step (ii) and/or step (iii) but prior to step (v);
(v) passing the stretched sheet to a first extraction zone where the processing plasticizer is substantially removed by extraction with an organic liquid;
(vi) passing the continuous sheet to a second extraction zone where residual organic extraction liquid is substantially removed by steam and/or water;
(vii) passing the continuous sheet through a dryer for substantial removal of residual water and remaining residual organic extraction liquid; and
(viii) optionally stretching the continuous sheet in at least one stretching direction above the elastic limit, wherein the stretching occurs during or immediately after step (v), step (vi), and/or step (vii) to form a microporous material.

Microporous materials used in the membranes of the present invention comprise a polyolefin matrix (a). The polyolefin matrix is present in the microporous material in an amount of at least 2 percent by weight. Polyolefins are polymers derived from at least one ethylenically unsaturated monomer. In certain embodiments of the present invention, the matrix comprises a plastomer. For example, the matrix may comprise a plastomer derived from butene, hexene, and/or octene. Suitable plastomers are available from ExxonMobil Chemical under the tradename “EXACT”.

In certain embodiments of the present invention, the matrix comprises a different polymer derived from at least one ethylenically unsaturated monomer, which may be used in place of or in combination with the plastomer. Examples include polymers derived from ethylene, propylene, and/or butene, such as polyethylene, polypropylene, and polybutene. High density and/or ultrahigh molecular weight polyolefins such as high density polyethylene are also suitable.

In a particular embodiment of the present invention, the polyolefin matrix comprises a copolymer of ethylene and butene.

Non-limiting examples of ultrahigh molecular weight (UHMW) polyolefin can include essentially linear UHMW polyethylene or polypropylene. Inasmuch as UHMW polyolefins are not thermoset polymers having an infinite molecular weight, they are technically classified as thermoplastic materials.

The ultrahigh molecular weight polypropylene can comprise essentially linear ultrahigh molecular weight isotactic polypropylene. Often the degree of isotacticity of such polymer is at least 95 percent, e.g., at least 98 percent.

While there is no particular restriction on the upper limit of the intrinsic viscosity of the UHMW polyethylene, in one non-limiting example, the intrinsic viscosity can range from 18 to 39 deciliters/gram, e.g., from 18 to 32 deciliters/gram. While there is no particular restriction on the upper limit of the intrinsic viscosity of the UHMW polypropylene, in one non-limiting example, the intrinsic viscosity can range from 6 to 18 deciliters/gram, e.g., from 7 to 16 deciliters/gram.

For purposes of the present invention, intrinsic viscosity is determined by extrapolating to zero concentration the reduced viscosities or the inherent viscosities of several dilute solutions of the UHMW polyolefin where the solvent is freshly distilled decahydronaphthalene to which 0.2 percent by weight, 3,5-di-tert-butyl-4-hydroxyhydrocinnamic acid, neopentanetetray ester [CAS Registry No. 6683-19-8] has been added. The reduced viscosities or the inherent viscosities of the UHMW polyolefin are ascertained from relative viscosities obtained at 135° C. using an Ubbelohde No. 1 viscometer in accordance with the general procedures of ASTM D 4020-81, except that several dilute solutions of differing concentration are employed.

The nominal molecular weight of UHMW polyethylene is empirically related to the intrinsic viscosity of the polymer in accordance with the following equation:

M=5.37×10⁴[\acute{η}]^{1.37}

wherein M is the nominal molecular weight and [\acute{η}] is the intrinsic viscosity of the UHMW polyethylene expressed in deciliters/gram. Similarly, the nominal molecular weight of UHMW polypropylene is empirically related to the intrinsic viscosity of the polymer according to the following equation:

M=8.88×10⁴[\acute{η}]^{1.25}

wherein M is the nominal molecular weight and [\acute{η}] is the intrinsic viscosity of the UHMW polypropylene expressed in deciliters/gram.

A mixture of substantially linear ultrahigh molecular weight polyethylene and lower molecular weight polyethylene can be used. In certain embodiments, the UHMW polyethylene has an intrinsic viscosity of at least 10 deciliters/gram, and the lower molecular weight polyethylene has an ASTM D 1238-86 Condition E melt index of less than 50 grams/10 minutes, e.g., less than 25 grams/10 minutes, such as less than 15 grams/10 minutes, and an ASTM D 1238-86 Condition F melt index of at least 0.1 gram/10 minutes, e.g., at least 0.5 gram/10 minutes, such as at least 1.0 gram/10 minutes. The amount of UHMW polyethylene used (as weight percent) in this embodiment is described in column 1, line 52 to column 2, line 18 of U.S. Pat. No. 5,196,262, which disclosure is incorporated herein by reference. More particularly, the weight percent of UHMW polyethylene used is described in relation to FIG. 6 of U.S. Pat. No. 5,196,262; namely, with reference to the polygons ABCDEF, GHCI or JHCK of FIG. 6, which Figure is incorporated herein by reference.

The nominal molecular weight of the lower molecular weight polyethylene (LMWPE) is lower than that of the UHMW polyethylene. LMWPE is a thermoplastic material and many different types are known. One method of classification is by density, expressed in grams/cubic centimeter and rounded to the nearest thousandth, in accordance with ASTM D 1248-84 (Reapproved 1989). Non-limiting examples of the densities of LMWPE are found in the following Table 1.

TABLE 1

| Type | Abbreviation | Density, g/cm³ |
|---|---|---|
| Low Density | LDPE | 0.910-0.925 |
| Polyethylene | | |
| Medium Density | MDPE | 0.926-0.940 |
| Polyethylene | | |
| High Density | HDPE | 0.941-0.965 |
| Polyethylene | | |

Any or all of the polyethylenes listed in Table 1 above may be used as the LMWPE in the matrix of the microporous material. HDPE may be used because it can be more linear than MDPE or LDPE. Processes for making the various LMWPE's are well known and well documented. They include the high pressure process, the Phillips Petroleum Company process, the Standard Oil Company (Indiana) process, and the Ziegler process. The ASTM D 1238-86 Condition E (that is, 190° C. and 2.16 kilogram load) melt index of the LMWPE is less than about 50 grams/10 minutes. Often the Condition E melt index is less than about 25 grams/10 minutes. The Condition E melt index can be less than about 15 grams/10 minutes. The ASTM D 1238-86 Condition F (that is, 190° C. and 21.6 kilogram load) melt index of the LMWPE is at least 0.1 gram/10 minutes, in many cases the Condition F melt index is at least 0.5 gram/10 minutes such as at least 1.0 gram/1 minutes.

The UHMWPE and the LMWPE may together constitute at least 65 percent by weight, e.g., at least 85 percent by weight, of the polyolefin polymer of the microporous material. Also, the UHMWPE and LMWPE together may constitute substantially 100 percent by weight of the polyolefin polymer of the microporous material.

In a particular embodiment of the present invention, the microporous material can comprise a polyolefin comprising ultrahigh molecular weight polyethylene, ultrahigh molecular weight polypropylene, high density polyethylene, high density polypropylene, or mixtures thereof.

If desired, other thermoplastic organic polymers also may be present in the matrix of the microporous material provided that their presence does not materially affect the properties of the microporous material substrate in an adverse manner. The amount of the other thermoplastic polymer which may be present depends upon the nature of such polymer, in general, a greater amount of other thermoplastic organic polymer may be used if the molecular structure contains little branching, few long side chains, and few bulky side groups, than when there is a large amount of branching, many long side chains, or many bulky side groups. Non-limiting examples of thermoplastic organic polymers that optionally may be present in the matrix of the microporous material include low density polyethylene, high density polyethylene, poly(tetrafluoroethylene), polypropylene, copolymers of ethylene and propylene, copolymers of ethylene and acrylic acid, and copolymers of ethylene and methacrylic acid. If desired, all or a portion of the carboxyl groups of carboxyl-containing copolymers can be neutralized with sodium, zinc or the like. Generally, the microporous material comprises at least 70 percent by weight of UHMW polyolefin, based on the weight of the matrix. In a non-limiting embodiment, the above-described other thermoplastic organic polymer are substantially absent from the matrix of the microporous material.

The microporous materials used in the membranes of the present invention further comprise finely divided, particulate, substantially water-insoluble silica filler (b) distributed throughout the matrix.

The particulate filler typically comprises precipitated silica particles. It is important to distinguish precipitated silica from silica gel inasmuch as these different materials have different properties. Reference in this regard is made to R. K. Iler, The Chemistry of Silica, John Wiley & Sons, New York (1979). Library of Congress Catalog No. QD 181.S6144, the entire disclosure of which is incorporate herein by reference. Note especially pages 15-29, 172-176, 218-233, 364-365, 462-465, 554-564, and 578-579. Silica gel is usually produced commercially at low pH by acidifying an aqueous solution of a soluble metal silicate, typically sodium silicate, with acid. The acid employed is generally a strong mineral acid such as sulfuric acid or hydrochloric acid although carbon dioxide is sometimes used. Inasmuch as there is essentially no difference in density between gel phase and the surrounding liquid phase while the viscosity is low, the gel phase does not settle out, that is to say, it does not precipitate. Silica gel, then, may be described as a nonprecipitated, coherent, rigid, three-dimensional network of contiguous particles of colloidal amorphous silica. The state of subdivision ranges from large, solid masses to submicroscopic particles, and the degree of hydration from almost anhydrous silica to soft gelatinous masses containing on the order of 100 parts of water per part of silica by weight.

Precipitated silica is usually produced commercially by combining an aqueous solution of a soluble metal silicate, ordinarily alkali metal silicate such as sodium silicate, and an acid so that colloidal particles will grow in weakly alkaline solution and be coagulated by the alkali metal ions of the resulting soluble alkali metal salt. Various acids may be used, including the mineral acids, but the preferred acid is carbon dioxide. In the absence of a coagulant, silica is not precipitated from solution at any pH. The coagulant used to effect precipitation may be the soluble alkali metal salt produced during formation of the colloidal silica particles, it may be added electrolyte such as a soluble inorganic or organic salt, or it may be a combination of both.

Precipitated silica, then, may be described as precipitated aggregates of ultimate particles of colloidal amorphous silica that have not at any point existed as macroscopic gel during the preparation. The sizes of the aggregates and the degree of hydration may vary widely.

Precipitated silica powders differ from silica gels that have been pulverized in ordinarily having a more open structure, that is, a higher specific pore volume. However, the specific surface area of precipitated silica as measured by the Brunauer, Emmet, Teller (BET) method using nitrogen as the adsorbate, is often lower than that of silica gel.

Many different precipitated silicas may be employed in the present invention, but the preferred precipitated silicas are those obtained by precipitation from an aqueous solution of sodium silicate using a suitable acid such as sulfuric acid, hydrochloric acid, or carbon dioxide. Such precipitated silicas are themselves known and processes for producing them are described in detail in the U.S. Pat. No. 2,940,830 and in West German Offenlegungsschrift No. 35 45 615, the entire disclosures of which are incorporated herein by reference, including especially the processes for making precipitated silicas and the properties of the products.

The precipitated silicas used in the present invention can be produced by a process involving the following successive steps:

(a) an initial stock solution of aqueous alkali metal silicate having the desired alkalinity is prepared and added to (or prepared in) a reactor equipped with means for heating the contents of the reactor,

(b) the initial stock solution within the reactor is heated to the desired reaction temperature,

(c) acidifying agent and additional alkali metal silicate solution are simultaneously added with agitation to the reactor while maintaining the alkalinity value and temperature of the contents of the reactor at the desired values,

(d) the addition of alkali metal silicate to the reactor is stopped, and additional acidifying agent is added to adjust the pH of the resulting suspension of precipitated silica to a desired acid value,

(e) the precipitated silica in the reactor is separated from the reaction mixture, washed to remove by-product salts, and

(f) dried to form the precipitated silica,

The washed silica solids are then dried using conventional drying techniques. Non-limiting examples of such techniques include oven drying, vacuum oven drying, rotary dryers, spray drying or spin flash drying. Non-limiting examples of spray dryers include rotary atomizers and nozzle spray dryers. Spray drying can be carried out using any suitable type of atomizer, in particular a turbine, nozzle, liquid-pressure or twin-fluid atomizer.

The washed silica solids may not be in a condition that is suitable for spray drying. For example, the washed silica solids may be too thick to be spray dried. In one aspect of the above-described process, the washed silica solids, e.g., the washed filter cake, are mixed with water to form a liquid suspension and the pH of the suspension adjusted, if required, with dilute acid or dilute alkali, e.g., sodium hydroxide, to from 6 to 7, e.g., 6.5, and then fed to the inlet nozzle of the spray dryer.

The temperature at which the silica is dried can vary widely but will be below the fusion temperature of the silica. Typically, the drying temperature will range from above 50° C. to less than 700° C., e.g., from above 100° C., e.g., 200° C., to 500° C. In one aspect of the above-described process, the silica solids are dried in a spray dryer having an inlet temperature of approximately 400° C. and an outlet temperature of approximately 105° C. The free water content of the dried silica can vary, but is usually in the range of from approximately 1 to 10 wt. %, e.g., from 4 to 7 wt %. As used herein, the term free water means water that can be removed from the silica by heating it for 24 hours at from 100° C. to 200° C., e.g., 105° C.

In one aspect of the process described herein, the dried silica is forwarded directly to a granulator where it is compacted and granulated to obtain a granular product. Dried silica can also be subjected to conventional size reduction techniques, e.g., as exemplified by grinding and pulverizing. Fluid energy milling using air or superheated steam as the working fluid can also be used. The precipitated silica obtained is usually in the form of a powder.

Most often, the precipitated silica is rotary dried or spray dried. Rotary dried silica particles have been observed to demonstrate greater structural integrity than spray dried silica particles. They are less likely to break into smaller particles during extrusion and other subsequent processing during production of the microporous material than are spray dried particles. Particle size distribution of rotary dried particles does not change as significantly as does that of spray dried particles during processing. Spray dried silica particles are more friable than rotary dried, often providing smaller particles during processing. It is possible to use a spray dried silica of a particular particle size such that the final particle size distribution in the membrane does not have a detrimental effect on water flux. In certain embodiments, the silica is reinforced; i.e., has a structural integrity such that porosity is preserved after extrusion. More preferred is a precipitated silica in which the initial number of silica particles and the initial silica particle size distribution is mostly unchanged by stresses applied during membrane fabrication. Most preferred is a silica reinforced such that a broad particle size distribution is present in the finished membrane. Blends of different types of dried silica and different sizes of silica may be used to provide unique properties to the membrane. For example, a blend of silicas with a bimodal distribution of particle sizes may be particularly suitable for certain separation processes. It is expected that external forces applied to silica of any type may be used to influence and tailor the particle size distribution, providing unique properties to the final membrane.

The surface of the particle can be modified in any manner well known in the art, including, but not limited to, chemically or physically changing its surface characteristics using techniques known in the art. For example, the silica may be surface treated with an anti-fouling moiety such as polyethylene glycol, carboxybetaine, sulfobetaine and polymers thereof, mixed valence molecules, oligomers and polymers thereof and mixtures thereof. Another embodiment may be a blend of silicas in which one silica has been treated with a positively charged moiety and the other silica has been treated with a negatively charged moiety. The silica may also be surface modified with functional groups that allow for targeted removal of specific contaminants in a fluid stream to be purified using the microfiltration membrane of the present invention. Untreated particles may also be used. Silica particles coated with hydrophilic coatings reduce fouling and may eliminate pre-wetting processing. Silica particles coated with hydrophobic coatings also reduce fouling and may aid degassing and venting of a system.

Precipitated silica typically has an average ultimate particle size of 1 to 100 nanometers.

The surface area of the silica particles, both external and internal due to pores, can have an impact on performance. High surface area fillers are materials of very small particle size, materials having a high degree of porosity or materials exhibiting both characteristics. Usually the surface area of the filler itself is in the range of from about 125 to about 700 square meters per gram (m²/g) as determined by the Brunauer, Emmett, Teller (BET) method according to ASTM C 819-77 using nitrogen as the adsorbate but modified by outgassing the system and the sample for one hour at 130° C. Often the BET surface area is in the range of from about 190 to 350 m²/g, more often, the silica demonstrates a BET surface area of 351 to 700 m²/g.

The BET/CTAB quotient is the ratio of the overall precipitated silica surface area including the surface area contained in pores only accessible to smaller molecules, such as nitrogen (BET), to the external surface area (CTAB). This ratio is typically referred to as a measure of microporosity. A high microporosity value, i.e., a high BET/CTAB quotient number, is a high proportion of internal surface—accessible to the small nitrogen molecule (BET surface area) but not to larger particles—to the external surface (CTAB).

It has been suggested that the structure, i.e., pores, formed within the precipitated silica during its preparation can have an impact on performance. Two measurements of this structure are the BET/CTAB surface area ratio of the precipitated silica noted above, and the relative breadth (γ) of the pore size distribution of the precipitated silica. The relative breadth (γ) of pore size distribution is an indication of how broadly the pore sizes are distributed within the precipitated silica particle. The lower the γ value, the narrower is the pore size distribution of the pores within the precipitated silica particle.

The silica CTAB values may be determined using a CTAB solution and the hereinafter described method. The analysis is performed using a Metrohm 751 Titrino automatic titrator, equipped with a Metrohm Interchangeable “Snap-In” 50 milliliter buret and a Brinkmann Probe Colorimeter Model PC 910 equipped with a 550 nm filter. In addition, a Mettler Toledo HB43 or equivalent is used to determine the 105° C. moisture loss of the silica and a Fisher Scientific Centrific™ Centrifuge Model 225 may be used for separating the silica and the residual CTAB solution. The excess CTAB can be determined by auto titration with a solution of Aerosol OT® until maximum turbidity is attained, which can be detected with the probe colorimeter. The maximum turbidity point is taken as corresponding to a millivolt reading of 150. Knowing the quantity of CTAB adsorbed for a given weight of silica and the space occupied by the CTAB molecule, the external specific surface area of the silica is calculated and reported as square meters per gram on a dry-weight basis.

Solutions required for testing and preparation include a buffer of pH 9.6, cetyl [hexadecyl]trimethyl ammonium bromide (CTAB), dioctyl sodium sulfosuccinate (Aerosol OT) and 1N sodium hydroxide. The buffer solution of pH 9.6 can be prepared by dissolving 3.101 g of orthoboric acid (99%; Fisher Scientific, Inc., technical grade, crystalline) in a one-liter volumetric flask, containing 500 milliliters of deionized water and 3.708 grams of potassium chloride solids (Fisher Scientific, Inc., technical grade, crystalline). Using a buret, 36.85 milliliters of the 1N sodium hydroxide solution was added. The solution is mixed and diluted to volume.

The CTAB solution is prepared using 11.0 g±0.005 g of powdered CTAB (cetyl trimethyl ammonium bromide, also known as hexadecyl trimethyl ammonium bromide, Fisher Scientific Inc., technical grade) onto a weighing dish. The CTAB powder is transferred to a 2-liter beaker and the weighing dish rinsed with deionized water. Approximately 700 milliliters of the pH 9.6 buffer solution and 1000 milliliters of distilled or deionized water is added to the 2-liter beaker and stirred with a magnetic stir bar. The beaker may be covered and stirred at room temperature until the CTAB powder is totally dissolved. The solution is transferred to a 2-liter volumetric flask, rinsing the beaker and stir bar with deionized water. The bubbles are allowed to dissipate, and the solution diluted to volume with deionized water. A large stir bar can be added and the solution mixed on a magnetic stirrer for approximately 10 hours. The CTAB solution can be used after 24 hours and for only 15 days. The Aerosol OT® (dioctyl sodium sulfosuccinate, Fisher Scientific Inc., 100% solid) solution may be prepared using 3.46 g±0.005 g, which is placed onto a weighing dish. The Aerosol OT on the weighing dish is rinsed into a 2-liter beaker, which contains about 1500 milliliter deionized water and a large stir bar. The Aerosol OT solution is dissolved and rinsed into a 2-liter volumetric flask. The solution is diluted to the 2-liter volume mark in the volumetric flask. The Aerosol OT® solution is allowed to age for a minimum of 12 days prior to use. The shelf life of the Aerosol OT solution is 2 months from the preparation date.

Prior to surface area sample preparation, the pH of the CTAB solution should be verified and adjusted as necessary to a pH of 9.6±0.1 using 1N sodium hydroxide solution. For test calculations a blank sample should be prepared and analyzed. 5 milliliters of the CTAB solution are pipetted and 55 milliliters deionized water added into a 150-milliliter beaker and analyzed on a Metrohm 751 Titrino automatic titrator. The automatic titrator is programmed for determination of the blank and the samples with the following parameters: Measuring point density=2, Signal drift=20, Equilibrium time=20 seconds, Start volume=0 ml, Stop volume=35 ml, and Fixed endpoint=150 mV. The buret tip and the colorimeter probe are placed just below the surface of the solution, positioned such that the tip and the photo probe path length are completely submerged. Both the tip and photo probe should be essentially equidistant from the bottom of the beaker and not touching one another. With minimum stirring (setting of 1 on the Metrohm 728 stirrer) the colorimeter is set to 100% T prior to every blank and sample determination and titration initiated with the Aerosol OT® solution. The end point can be recorded as the volume (ml) of titrant at 150 mV.

For test sample preparation, approximately 0.30 grams of powdered silica was weighed into a 50-milliliter container containing a stir bar. Granulated silica samples, were riffled (prior to grinding and weighing) to obtain a representative sub-sample. A coffee mill style grinder was used to grind granulated materials. Then 30 milliliters of the pH adjusted CTAB solution was pipetted into the sample container containing the 0.30 grams of powdered silica. The silica and CTAB solution was then mixed on a stirrer for 35 minutes. When mixing was completed, the silica and CTAB solution were centrifuged for 20 minutes to separate the silica and excess CTAB solution. When centrifuging was completed, the CTAB solution was pipetted into a clean container minus the separated solids, referred to as the “centrifugate”. For sample analysis, 50 milliliters of deionized water was placed into a 150-milliliter beaker containing a stir bar. Then 10 milliliters of the sample centrifugate was pipetted for analysis into the same beaker. The sample was analyzed using the same technique and programmed procedure as used for the blank solution.

For determination of the moisture content, approximately 0.2 grams of silica was weighed onto the Mettler Toledo HB43 while determining the CTAB value. The moisture analyzer was programmed to 105° C. with the shut-off 5 drying criteria. The moisture loss was recorded to the nearest+0.1%.

The external surface area is calculated using the following equation,

$$CTAB Surface Area ( dried basis ) [ {m}^{2} \text{/} g ] = \frac{( 2 {V}_{o} - V ) \times ( 4774 )}{( {V}_{o} W ) \times ( 100 - Vol )}$$

wherein,
Vₒ=Volume in ml of Aerosol OT® used in the blank titration.
V=Volume in ml of Aerosol OT® used in the sample titration.
W=sample weight in grams.
Vol=% moisture loss (Vol represents “volatiles”).

Typically, the CTAB surface area of the silica particles used in the present invention ranges from 120 to 500 m²/g. Often, the silica demonstrates a CTAB surface area of 170-280 m²/g. More often, the silica demonstrates a CTAB surface area of 281-500 m²/g.

In certain embodiments of the present invention, the BET value of the precipitated silica will be a value such that the quotient of the BET surface area in square meters per gram to the CTAB surface area in square meters per gram is equal to or greater than 1.0. Often, the BET to CTAB ratio is 1.0-1.5. More often, the BET to CTAB ratio is 1.5-2.0.

The BET surface area values reported in the examples of this application were determined in accordance with the Brunauer-Emmet-Teller (BET) method in accordance with ASTM D1993-03. The BET surface area can be determined by fitting five relative-pressure points from a nitrogen sorption isotherm measurement made with a Micromeritics TriStar 3000™ instrument. A flow Prep-060™ station provides heat and a continuous gas flow to prepare samples for analysis. Prior to nitrogen sorption, the silica samples are dried by heating to a temperature of 160° C. in flowing nitrogen (P5 grade) for at least one (1) hour.

The filler particles can constitute from 10 to 90 percent by weight of the microporous material. For example, such filler particles can constitute from 25 to 90 percent by weight of the microporous material, such as from 30 percent to 90 percent by weight of the microporous material, or from 40 to 90 percent by weight of the microporous material, or from 50 to 90 percent by weight of the microporous material and even from 60 percent to 90 percent by weight of the microporous material. The filler is typically present in the microporous material of the present invention in an amount of 50 percent to about 85 percent by weight of the microporous material. Often the weight ratio of silica to polyolefin in the microporous material is 1.7 to 3.5:1. Alternatively the weight ratio of filler to polyolefin in the microporous material may be greater than 4:1.

The microporous material used in the membrane of the present invention further comprises a network of interconnecting pores (c) communicating throughout the microporous material.

On an impregnant-free basis, such pores can comprise at least 15 percent by volume, e.g. from at least 20 to 95 percent by volume, or from at least 25 to 95 percent by volume, or from 35 to 70 percent by volume of the microporous material. Often the pores comprise at least 35 percent by volume, or even at least 45 percent by volume of the microporous material. Such high porosity provides higher surface area throughout the microporous material, which in turn facilitates removal of contaminants from a fluid stream and higher flux rates of a fluid stream through the membrane.

As used herein and in the claims, the porosity (also known as void volume) of the microporous material, expressed as percent by volume, is determined according to the following equation:

Porosity=100[1−d₁/d₂]

wherein d₁ is the density of the sample, which is determined from the sample weight and the sample volume as ascertained from measurements of the sample dimensions, and d₂ is the density of the solid portion of the sample, which is determined from the sample weight and the volume of the solid portion of the sample. The volume of the solid portion of the same is determined using a Quantachrome stereopycnometer (Quantachrome Corp.) in accordance with the accompanying operating manual.

The volume average diameter of the pores of the microporous material can be determined by mercury porosimetry using an Autopore III porosimeter (Micromeretics, Inc.) in accordance with the accompanying operating manual. The volume average pore radius for a single scan is automatically determined by the porosimeter. In operating the porosimeter, a scan is made in the high pressure range (from 138 kilopascals absolute to 227 megapascals absolute). If approximately 2 percent or less of the total intruded volume occurs at the low end (from 138 to 250 kilopascals absolute) of the high pressure range, the volume average pore diameter is taken as twice the volume average pore radius determined by the porosimeter. Otherwise, an additional scan is made in the low pressure range (from 7 to 165 kilopascals absolute) and the volume average pore diameter is calculated according to the equation:

d=2[v₁r₁/w₁+v₂r₂/w₂]/[v₁/w₁+v₂/w₂]

wherein d is the volume average pore diameter, v₁ is the total volume of mercury intruded in the high pressure range, v₂ is the total volume of mercury intruded in the low pressure range, r₁ is the volume average pore radius determined from the high pressure scan, r₂ is the volume average pore radius determined from the low pressure scan, w₁ is the weight of the sample subjected to the high pressure scan, and w₂ is the weight of the sample subjected to the low pressure scan. The volume average diameter of the pores can be in the range of from 0.001 to 0.70 micrometers, e.g., from 0.30 to 0.70 micrometers.

In the course of determining the volume average pore diameter of the above procedure, the maximum pore radius detected is sometimes noted. This is taken from the low pressure range scan, if run; otherwise it is taken from the high pressure range scan. The maximum pore diameter is twice the maximum pore radius. Inasmuch as some production or treatment steps, e.g., coating processes, printing processes, impregnation processes and/or bonding processes, can result in the filling of at least some of the pores of the microporous material, and since some of these processes irreversibly compress the microporous material, the parameters in respect of porosity, volume average diameter of the pores, and maximum pore diameter are determined for the microporous material prior to the application of one or more of such production or treatment steps.

To prepare the microporous materials of the present invention, filler, polymer powder (polyolefin polymer), processing plasticizer, and minor amounts of lubricant and antioxidant are mixed until a substantially uniform mixture is obtained. The weight ratio of filler to polymer powder employed in forming the mixture is essentially the same as that of the microporous material substrate to be produced. The mixture, together with additional processing plasticizer, is introduced to the heated barrel of a screw extruder. Attached to the extruder is a die, such as a sheeting die, to form the desired end shape.

In an exemplary manufacturing process, when the material is formed into a sheet or film, a continuous sheet or film formed by a die is forwarded to a pair of heated calender rolls acting cooperatively to form continuous sheet of lesser thickness than the continuous sheet exiting from the die. The final thickness may depend on the desired end-use application. The microporous material may have a thickness ranging from 0.7 to 18 mil (17.8 to 457.2 microns) and demonstrates a bubble point of 10 to 80 psi based on ethanol.

The sheet exiting the calendar rolls is then stretched in at least one stretching direction above the elastic limit. Stretching may alternatively take place during or immediately after exiting from the sheeting die or during calendaring, or multiple times, but it is typically done prior to extraction. Stretched microporous material substrate may be produced by stretching the intermediate product in at least one stretching direction above the elastic limit. Usually the stretch ratio is at least about 1.5. In many cases the stretch ratio is at least about 1.7. Preferably it is at least about 2. Frequently the stretch ratio is in the range of from about 1.5 to about 15. Often the stretch ratio is in the range of from about 1.7 to about 10. Preferably the stretch ratio is in the range of from about 2 to about 6,

The temperatures at which stretching is accomplished may vary widely. Stretching may be accomplished at about ambient room temperature, but usually elevated temperatures are employed. The intermediate product may be heated by any of a wide variety of techniques prior to, during, and/or after stretching. Examples of these techniques include radiative heating such as that provided by electrically heated or gas fired infrared heaters, convective heating such as that provided by recirculating hot air, and conductive heating such as that provided by contact with heated rolls. The temperatures which are measured for temperature control purposes may vary according to the apparatus used and personal preference. For example, temperature-measuring devices may be placed to ascertain the temperatures of the surfaces of infrared heaters, the interiors of infrared heaters, the air temperatures of points between the infrared heaters and the intermediate product, the temperatures of circulating hot air at points within the apparatus, the temperature of hot air entering or leaving the apparatus, the temperatures of the surfaces of rolls used in the stretching process, the temperature of heat transfer fluid entering or leaving such rolls, or film surface temperatures. In general, the temperature or temperatures are controlled such that the intermediate product is stretched about evenly so that the variations, if any, in film thickness of the stretched microporous material are within acceptable limits and so that the amount of stretched microporous material outside of those limits is acceptably low. It will be apparent that the temperatures used for control purposes may or may not be close to those of the intermediate product itself since they depend upon the nature of the apparatus used, the locations of the temperature-measuring devices, and the identities of the substances or objects whose temperatures are being measured.

In view of the locations of the heating devices and the line speeds usually employed during stretching, gradients of varying temperatures may or may not be present through the thickness of the intermediate product. Also because of such line speeds, it is impracticable to measure these temperature gradients. The presence of gradients of varying temperatures, when they occur, makes it unreasonable to refer to a singular film temperature. Accordingly, film surface temperatures, which can be measured, are best used for characterizing the thermal condition of the intermediate product.

These are ordinarily about the same across the width of the intermediate product during stretching although they may be intentionally varied, as for example, to compensate for intermediate product having a wedge-shaped cross-section across the sheet. Film surface temperatures along the length of the sheet may be about the same or they may be different during stretching.

The film surface temperatures at which stretching is accomplished may vary widely, but in general they are such that the intermediate product is stretched about evenly, as explained above. In most cases, the film surface temperatures during stretching are in the range of from about 20° C. to about 220° C. Often such temperatures are in the range of from about 50° C. to about 200° C. From about 75° C. to about 180° C. is preferred.

Stretching may be accomplished in a single step or a plurality of steps as desired. For example, when the intermediate product is to be stretched in a single direction (uniaxial stretching), the stretching may be accomplished by a single stretching step or a sequence of stretching steps until the desired final stretch ratio is attained. Similarly, when the intermediate product is to be stretched in two directions (biaxial stretching), the stretching can be conducted by a single biaxial stretching step or a sequence of biaxial stretching steps until the desired final stretch ratios are attained. Biaxial stretching may also be accomplished by a sequence of one of more uniaxial stretching steps in one direction and one or more uniaxial stretching steps in another direction, Biaxial stretching steps where the intermediate product is stretched simultaneously in two directions and uniaxial stretching steps may be conducted in sequence in any order. Stretching in more than two directions is within contemplation. It may be seen that the various permutationes of steps are quite numerous. Other steps, such as cooling, heating, sintering, annealing, reeling, unreeling, and the like, may optionally be included in the overall process as desired.

Various types of stretching apparatus are well known and may be used to accomplish stretching of the intermediate product. Uniaxial stretching is usually accomplished by stretching between two rollers wherein the second or downstream roller rotates at a greater peripheral speed than the first or upstream roller. Uniaxial stretching can also be accomplished on a standard tentering machine. Biaxial stretching may be accomplished by simultaneously stretching in two different directions on a tentering machine. More commonly, however, biaxial stretching is accomplished by first uniaxially stretching between two differentially rotating rollers as described above, followed by either uniaxially stretching in a different direction using a tenter machine or by biaxially stretching using a tenter machine. The most common type of biaxial stretching is where the two stretching directions are approximately at right angles to each other. In most cases where continuous sheet is being stretched, one stretching direction is at least approximately parallel to the long axis of the sheet (machine direction) and the other stretching direction is at least approximately perpendicular to the machine direction and is in the plane of the sheet (transverse direction).

Stretching the sheets prior to extraction of the processing plasticizer allows for larger pore sizes than in microporous materials conventionally processed, thus making the microporous material particularly suitable for use in the microfiltration membranes of the present invention, it is also believed that stretching of the sheets prior to extraction of the processing plasticizer minimizes thermal shrinkage after processing.

The product passes to a first extraction zone where the processing plasticizer is substantially removed by extraction with an organic liquid which is a good solvent for the processing plasticizer, a poor solvent for the organic polymer, and more volatile than the processing plasticizer. Usually, but not necessarily, both the processing plasticizer and the organic extraction liquid are substantially immiscible with water. The product then passes to a second extraction zone where the residual organic extraction liquid is substantially removed by steam and/or water. The product is then passed through a forced air dryer for substantial removal of residual water and remaining residual organic extraction liquid. From the dryer the microporous material may be passed to a take-up roll, when it is in the form of a sheet.

The processing plasticizer has little solvating effect on the thermoplastic organic polymer at 60° C., only a moderate solvating effect at elevated temperatures on the order of about 100° C., and a significant solvating effect at elevated temperatures on the order of about 200° C. It is a liquid at room temperature and usually it is processing oil such as paraffinic oil, naphthenic oil, or aromatic oil. Suitable processing oils include those meeting the requirements of ASTM D 2226-82, Types 103 and 104. Those oils which have a pour point of less than 22° C., or less than 10° C., according to ASTM D 97-66 (reapproved 1978) are used most often. Examples of suitable oils include Shellflex® 412 and Shellflex® 371 oil (Shell Oil Co.) which are solvent refined and hydrotreated oils derived from naphthenic crude. It is expected that other materials, including the phthalate ester plasticizers such as dibutyl phthalate, bis(2-ethylhexyl)phthalate, diisodecyl phthalate, dicyclohexyl phthalate, butyl benzyl phthalate, and ditridecyl phthalate will function satisfactorily as processing plasticizers.

There are many organic extraction liquids that can be used. Examples of suitable organic extraction liquids include 1,1,2-trichloroethylene, perchloroethylene, 1,2-dichloroethane, 1,1,1-trichloroethane, 1,1,2-trichloroethane, methylene chloride, chloroform, isopropyl alcohol, diethyl ether and acetone.

In the above described process for producing microporous material substrate, extrusion and calendering are facilitated when the filler carries much of the processing plasticizer. The capacity of the filler particles to absorb and hold the processing plasticizer is a function of the surface area of the filler. Therefore the filler typically has a high surface area as discussed above. Inasmuch as it is desirable to essentially retain the filler in the microporous material substrate, the filler should be substantially insoluble in the processing plasticizer and substantially insoluble in the organic extraction liquid when microporous material substrate is produced by the above process.

The residual processing plasticizer content is usually less than 15 percent by weight of the resulting microporous material and this may be reduced even further to levels such as less than 5 percent by weight, by additional extractions using the same or a different organic extraction liquid.

The resulting microporous materials may be further processed depending on the desired application. For example, a hydrophilic or hydrophobic coating may be applied to the surface of the microporous material to adjust the surface energy of the material. Also, the microporous material may be adhered to a support layer such as a fiberglass layer to provide additional structural integrity, depending on the particular end use. Additional optional stretching of the continuous sheet in at least one stretching direction may also be done during or immediately after any of the steps upon extrusion in step (ii). In the production of a microfiltration membrane of the present invention, typically the only stretching step occurs prior to extraction of the plasticizer.

The microporous materials prepared as described above are suitable for use in the membranes of the present invention, capable of removing particulates from a fluid stream ranging in size from 0.05 TO 1.5 microns. The membranes also serve to remove molecular contaminants from a fluid stream by adsorption or by physical rejection due to molecular size.

The membranes of the present invention may be used in a method of separating suspended or dissolved materials from a fluid stream, such as removing one or more contaminants from a fluid (liquid or gaseous) stream, or concentrating desired components in a depleted stream for recirculation through a system, such as reconstituting an electrodeposition bath. The method comprises contacting the stream with the membrane, typically by passing the stream through the membrane. Examples of contaminants include toxins, such as neurotoxins; heavy metal; hydrocarbons; oils; dyes; neurotoxins; pharmaceuticals; and/or pesticides. When the stream is a liquid stream, it is usually passed through the membrane at a flux rate of 0.1 to 10, usually 0.2 to 2.0 ml/(cm² psi min). When the stream is a gaseous stream, it is usually passed through the membrane at a flux rate of 0.2 to 2.0 ml/(cm² psi min).

### EXAMPLES

Whereas particular embodiments of this invention have been described above for purposes of illustration, it will be evident to those skilled in the art that numerous variations of the details of the present invention may be made without departing from the scope of the invention as defined in the appended claims.

Part I describes the formulations of Examples 1-4 in Table 1 and the preparation of the microporous sheet materials. Part II describes the properties of the sheet materials prior to stretching for Examples 1-4 in Table 2. Part III describes the stretching conditions used at Parkinson Technology to produce the stretched materials of Examples 1-4 in Tables 3-5. Part IV describes the properties of the sheet materials after stretching in Tables 6-8. Part V describes the pore size and water flux properties of Examples 1-3 and Comparative Examples (CE) 1-3 in Table 9. Part VI describes the performance of filters of Example 3C and CE-2 and 4 with pond water in Table 10 and a metal ion analysis of the pond water and filtrate of Example 3C and CE-4 in Table 11.

### Part 1—Preparation of Microporous Sheet Materials of Examples 1-4

In the following Examples 1-4, the formulations used to prepare the silica-containing microporous sheet materials of Part I are listed in Table 1. Examples 1 and 2 were prepared in the manner described hereinafter. Examples 3 and 4 were extruded and calendered into final sheet form using an extrusion system that was a production sized version of the system described below. Residual oil in Examples 3 and 4 was removed using a 1,1,2-trichloroethylene (TCE) oil extraction process in tandem with the production sized extrusion and calendering system, all carried out as described in U.S. Pat. No. 5,196,262, at column 7, line 52, to column 8, line 47.

The dry ingredients of Examples 1 and 2 were separately weighed into a FM-130D Littleford plough blade mixer with one high intensity chopper style mixing blade in the order and amounts, in pounds (lb) and kilograms (kg) specified in Table 1. The dry ingredients were premixed for 15 seconds using the plough blades only. The process oil was then pumped in via a double diaphragm pump through a spray nozzle at the top of the mixer, with only the plough blades running. The pumping time for the examples varied between 45-60 seconds. The high intensity chopper blade was turned on, along with the plough blades, and the mix was mixed for 30 seconds. The mixer was shut off and the internal sides of the mixer were scrapped down to insure all ingredients were evenly mixed. The mixer was turned back on with both high intensity chopper and plough blades turned on, and the mix was mixed for an additional 30 seconds. The mixer was turned off and the mix dumped into a storage container.

TABLE 1

| Ingredients | Ex. 1 | EX. 2 | Ex. 3 | Ex. 4 |
|---|---|---|---|---|
| Silica^{(a)} | 4.07 (1.8) | 5.75 (2.6) | 500 (226.8) | 500 (226.8) |
| lb (kg) | | | | |
| UHMWPE^{(b)} | 2.38 (1.1) | 5.73 (2.6) | 144 (65.3) | 155 (70.3) |
| lb (kg) | | | | |
| HDPE^{(c)} | 0 (0) | 0 (0) | 144 (65.3) | 195 (88.5) |
| lb (kg) | | | | |
| Anti- | 0.04 (0.02) | 0.04 (0.02) | 4 (1.8) | 4 (1.8) |
| oxidant^{(d)} | | | | |
| lb (kg) | | | | |
| Lubricant^{(e)} | 0.04 (0.02) | 0.04 (0.02) | 4 (1.8) | 4 (1.8) |
| lb (kg) | | | | |
| Process oil^{(f)} | 9.50 (4.3) | 11.00 (5.0) | 850 (385.6) | 835 (378.7) |
| lb (kg) | | | | |

^{(a)}Silica Hi-Sil ® WB37 precipitated silica was used and was obtained commercially from PPG Industries, Inc.
^{(b)}GUR ® 4150 Ultra High Molecular Weight Polyethylene (UHMWPE), obtained commercially from Ticona Corp and reported to have a molecular weight of about 9.2 million grams per mole.
^{(c)}FINA ® 1288 High Density Polyethylene (HDPE), obtained commercially from Total Petrochemicals.
^{(d)}IRGANOX ® B215 antioxidant, obtained commercially from BASF.
^{(e)}SYNPRO ® 1580 reported to be a calcium-zinc stearate lubricant, obtained commercially from Ferro.
^{(f)}TUFFLO ® 6056 process oil, obtained commercially from PPC Lubricants.

The mixtures of ingredients specified in Table 1 were extruded and calendered into sheet form using an extrusion system that included the following described feeding, extrusion and calendering systems. A gravimetric loss in weight feed system (K-tron model #K2MLT35D5) was used to feed each of the respective mixes into a 27 millimeter twin screw extruder (Leistritz Micro-27 mm) The extruder barrel was comprised of eight temperature zones and a heated adaptor to the sheet die. The extrusion mixture feed port was located just prior to the first temperature zone. An atmospheric vent was located in the third temperature zone. A vacuum vent was located in the seventh temperature zone.

Each mixture was fed into the extruder at a rate of 90 grams/minute. Additional processing oil also was injected at the first temperature zone, as required, to achieve desired total oil content in the extruded sheet. The oil contained in the extruded sheet (extrudate) being discharged from the extruder is referenced herein as the percent extrudate oil weight, which was based on the total weight of the sample. The arithmetic average of the percent extrudate oil weight for Examples 1 and 2 was about 66% and for Examples 3 and 4 was about 4%. Extrudate from the barrel was discharged into a 38 centimeter wide sheet die having a 1.5 millimeter discharge opening. The extrusion melt temperature was 203-210° C.

The calendering process was accomplished using a three-roll vertical calender stack with one nip point and one cooling roll. Each of the rolls had a chrome surface. Roll dimensions were approximately 41 centimeters in length and 14 centimeters (cm) in diameter. The top roll temperature was maintained between 269° F. to 285° F. (132° C. to 141° C.). The middle roll temperature was maintained at a temperature from 279° F. to 287° F. (137° C. to 142° C.). The bottom roll was a cooling roll wherein the temperature was maintained between 60° F. to 80° F. (16° C. to 27° C.). The extrudate was calendered into sheet form and passed over the bottom water cooled roll and wound up. A length of about 1.5 meters of material that was about 19 cm in width was rolled around a mesh screen and immersed in about 2 liters of trichloroethylene for 60 to 90 minutes. The material was removed, air dried and subjected to the test methods described in Table 2.

### Part II—Properties of the Sheets Prior to Stretching

The results of physical testing are listed in Table 2. The different sheets had the thickness in mils listed below. Thickness was determined using an Ono Sokki thickness gauge EG-225. Two 11 cm×13 cm specimens were cut from each sample and the thickness for each specimen was measured in twelve places (at least ¾ of an inch (1.91 cm) from any edge).

Property values indicated by MD (machine direction) were obtained on samples whose major axis was oriented along the length of the sheet. CD (transverse direction; cross machine direction) properties were obtained from samples whose major axis was oriented across the sheet.

TABLE 2

| Property | Ex. 1 | Ex. 2 | Ex. 3 | Ex. 4 |
|---|---|---|---|---|
| Porosity (Gurley Sec.)^{(g)} | 725 | 524 | 1696 | 5623 |
| Average Thickness (mil) | 4.90 | 4.88 | 7.15 | 10.75 |
| 150° C. CD Thermal Shrinkage | 0.001 | 0.000 | 0.0 | 0.05 |
| Ratio^{(h)} | | | | |
| 150° C. MD Thermal Shrinkage | 0.004 | 0.002 | 0.13 | 0.14 |
| Ratio^{(h)} | | | | |
| MD Maximum Elongation⁽ⁱ⁾ (%) | 243 | 33 | 452 | 716 |
| MD Maximum Tensile | 618 | 1643 | 1488 | 1893 |
| Strength⁽ⁱ⁾ | | | | |
| (psi) | | | | |
| CD Maximum Elongation⁽ⁱ⁾ (%) | 470 | 546 | 667 | 948 |
| CD Maximum Tensile Strength⁽ⁱ⁾ | 700 | 1019 | 636 | 850 |
| (psi) | | | | |

^{(g)}Porosity was measure in “Gurley seconds” which represents the time in seconds to pass 100 cc of air through a 1 inch square area using a pressure differential of 4.88 inches of water with a Gurley densometer, model 4340, manufactured by GPI Gurley Precision Instruments of Troy, New York. All testing was done in accordance with the unit's manual, but TAPPI T538 om-08 can also be referenced for the basic principles.
^{(h)}Heat shrinkage was determined following the procedure of ASTM D 1204-84 except that samples of 15 cm × 25 cm were used in place of 25 cm × 25 cm.
⁽ⁱ⁾The Maximum Elongation or tensile modulus of elasticity and the Maximum Tensile Strength or tensile energy to break the samples was determined following the procedure of ADTM D-882-02.

### Part III—Stretching Conditions

Stretching was conducted in Parkinson Technology using the Marshall and Williams Biaxial Orientation Plastic Processing System. The Machine Direction Oriented (MDO) stretching of the material from Part II was accomplished by heating the web and stretching it in the machine direction over a series of rollers maintained at the temperatures listed in Tables 3, 4 and 5. Transverse Direction Orientation (TDO) stretching used after MDO stretching in Tables 4 and 5 was accomplished by heating the web and stretching it in the transverse (or cross) direction on a tenter frame. The tenter frame consists of two horizontal chain tracks, on which clip and chain assemblies hold the material in place. The MDO and TDO conditions provided biaxial stretching of the material. The oven was an enclosed hot air oven with 3 heated zones; the pre-heat, stretch, and anneal sections. Processing conditions for material from Example 3 designated 3A, 3B and 3C is included in Table 3. Processing conditions for material from Example 4 designated 4A, 4B, 4C, 4D and 4E is included in Table 4. Processing conditions for material from Examples 1 and 2 designated 1A and 1B and 2A is included in Table 5.

TABLE 3
Stretching Conditions for Example 3

| | | MDO Stretch Info | | | | | |
|---|---|---|---|---|---|---|---|
| | | Roll Temperatures (° C.) | | | | | |
| Exam- | Stretching | | | Slow | Fast | | |
| ple | Stretch | Preheat | Preheat | Draw | Draw | Anneal | Cooling |
| # | Ratio | Roll 1 | Roll 2 | Roll | Roll | Roll | Roll |
| 3A | 3:1 | 135 | 135 | 135 | 135 | 141 | 24 |
| 3B | 4:1 | 135 | 135 | 135 | 135 | 141 | 24 |
| 3C | 5:1 | 132 | 132 | 132 | 132 | 141 | 24 |

TABLE 4
Biaxial Stretching Conditions for Example 4

| | | MOD stretching | | | | TDO | | |
|---|---|---|---|---|---|---|---|---|
| | | conditions | | | | conditions | | |
| | | Preheat | Anneal | Cooling | | Oven | Slow | Fast |
| | | Roll | Roll | Roll | | Zone 1 | Draw | Draw |
| Example | Stretching | Temp | Temp | Temp | Stretching | Tem | Roll | Roll |
| # | ratio | (° C.) | (° C.) | (° C.) | ratio | (° C.) | (m/min)* | (m/min)* |
| 4A | 3.5 | 132 | 141 | 24 | 3 | 135 | | |
| 4B | 3 | 132 | 141 | 24 | 2.5 | 132 | 3.2 | 9.5 |
| 4C | 3 | 132 | 141 | 24 | 3 | 132 | 3.0 | 9.5 |
| 4D | 3 | 132 | 141 | 24 | 3 | 132 | 3.2 | 9.5 |
| 4E | 3.5 | 132 | 141 | 24 | 3 | 132 | 3.2 | 10.7 |

*meters per minute

TABLE 5
Biaxial Stretching for Examples 1 and 2

| | | MOD stretching | | | TDO | | |
|---|---|---|---|---|---|---|---|
| | | conditions | | | conditions | | |
| | | 1^{st} & 2^{nd} | Cooling | | Oven | | Fast |
| | | Preheat and | Roll | | Zone 1 | Slow | Draw |
| | Stretch | Anneal Rolls | Temp | Stretch | Temp | Draw Roll | Roll |
| Example # | ratio | Temps (° C.) | (° C.) | ratio | (° C.) | (m/min)* | (m/min)* |
| 1A | 2 | 110 | 24 | 2 | 121 | 3.1 | 6.4 |
| 1B | 2 | 110 | 24 | 3 | 121 | 3.1 | 6.4 |
| 2A | 2 | 110 | 24 | 3 | 121 | 1.6 | 3.2 |

Part IV—Properties of the Example Sheets after Stretching

The porosity, thickness and shrinkage properties and the maximum elongation and tensile strength of Examples 3A-3C are listed in Table 6. The properties for Examples 4A-4E are listed in Table 7. The properties of Examples 1A & 1B, and 2A are listed in Table 8.

TABLE 6
Properties of Example 3A-3C after Stretching

| Property | Ex. 3A | Ex. 3B | Ex. 3C |
|---|---|---|---|
| Porosity (Gurley Sec.)^{(g)} | 81.5 | 75.9 | 53.1 |
| Average Thickness (mil) | 4.10 | 3.90 | 3.60 |
| 100° C. CD % Thermal Shrinkage^{(h)} | 0.0 | 0.0 | 0.0 |
| 150° C. CD % Thermal Shrinkage^{(h)} | 0.5 | 1.3 | 1.2 |
| 100° C. MD % Thermal Shrinkage^{(h)} | 2.0 | 2.0 | 2.8 |
| 150° C. MD % Thermal Shrinkage^{(h)} | 10.7 | 24.4 | 26.1 |
| MD Maximum Elongation⁽ⁱ⁾ (%) | 33 | 24 | 18 |
| MD Maximum Tensile Strength⁽ⁱ⁾ (psi) | 3575 | 3461 | 3527 |
| CD Maximum Elongation⁽ⁱ⁾ (%) | 215 | 195 | 210 |
| CD Maximum Tensile Strength⁽ⁱ⁾ (psi) | 484 | 429 | 393 |

TABLE 7
Properties of Example 4A-4E after Stretching

| Property | Ex. 4A | Ex. 4B | Ex. 4C | Ex. 4D | Ex. 4E |
|---|---|---|---|---|---|
| Porosity (Gurley Sec.)^{(g)} | 46.1 | 36.9 | 26.9 | 26.7 | 24.7 |
| Average Thickness (mil) | 6.57 | 6.59 | 5.82 | 5.43 | 5.74 |
| 100° C. CD % Thermal Shrinkage^{(h)} | 1.2 | 1.2 | 2.0 | 2.0 | 2.0 |
| 150° C. CD % Thermal Shrinkage^{(h)} | 9.9 | 13.0 | 24.0 | 29.0 | 43.2 |
| 100° C. MD % Thermal Shrinkage^{(h)} | 2.0 | 1.3 | 4.0 | 4.1 | 5.3 |
| 150° C. MD % Thermal Shrinkage^{(h)} | 14.1 | 15.9 | 33.0 | 38.9 | 41.5 |
| MD Maximum Elongation⁽ⁱ⁾ (%) | 45 | 36 | 40 | 32 | 22 |
| MD Maximum Tensile Strength⁽ⁱ⁾ (psi) | 2481 | 1268 | 982 | 773 | 1112 |
| CD Maximum Elongation⁽ⁱ⁾ (%) | 118 | 76 | 42 | 40 | 60 |
| CD Maximum Tensile Strength⁽ⁱ⁾ (psi) | 616 | 845 | 831 | 889 | 746 |

TABLE 8
Properties of Example 1A & 1B and 2A after Stretching

| Property | Ex. 1A | Ex. 1B | Ex. 2A |
|---|---|---|---|
| Porosity (Gurley Sec.)^{(g)} | 187.8 | 87.7 | 52 |
| Average Thickness (mil) | 2.35 | 0.92 | 0.88 |
| 100° C. CD % Thermal Shrinkage^{(h)} | 1.2 | 1.2 | 1.2 |
| 150° C. CD % Thermal Shrinkage^{(h)} | 3.5 | 2.5 | 3.3 |
| 100° C. MD Thermal Shrinkage^{(h)} | 1.2 | 2.0 | 3.3 |
| 150° C. MD Thermal Shrinkage^{(h)} | 3.7 | 5.5 | 8.9 |
| MD Maximum Elongation⁽ⁱ⁾ (%) | 82 | 45 | 59 |
| MD Maximum Tensile Strength⁽ⁱ⁾ (psi) | 2033 | 1144 | 1078 |
| CD Maximum Elongation⁽ⁱ⁾ (%) | 341 | 98 | 72 |
| CD Maximum Tensile Strength⁽ⁱ⁾ (psi) | 536 | 908 | 1174 |

### Part V—Example and Comparative Example Membrane Pore Size and Water Flux Properties

ASTM F316-03 was followed to determine the pore size characteristics and the Bubble point for Examples 1A and 1B, 2A and 2B and 3A-3C reported as PSI. Comparative Examples (CE) included as CE-1 was 0.2 micron polyvinylidene difluoride filter; as CE-2, a 0.2 micron nylon filter; and as CE-3, a 0.2 micron polyethersulfone filter. Comparative Examples 1-3 were obtained from the Sterlitech Corp. The Water Flux was determined with an active area of 17 cm² under 10 psi vacuum with distilled water at 25° C. Results are listed in Table 9.

TABLE 9
Pore Size, Bubble Point and Water Flux for
Examples 1A, 1B, 2A, 2B, 3A-3C, CE-1-3

| | Mean Pore | Maximum Pore | Bubble | |
|---|---|---|---|---|
| | Size | Size | Point | Water Flux |
| Example # | (microns) | (microns) | (PSI) | (ml/cm²) |
| 1A | 0.149 | 0.236 | 27 | 0.693 |
| 1B | 0.172 | 0.268 | 24 | 1.040 |
| 2A | 0.011 | 0.020 | 52 | 0.416 |
| 2B | 0.202 | 0.362 | 18 | 0.960 |
| 3A | 0.097 | 0.135 | 48 | 0.233 |
| 3B | 0.101 | 0.153 | 43 | 0.249 |
| 3C | 0.098 | 0.131 | 41 | 0.260 |
| CE-1 | 0.187 | 0.466 | 14 | 0.891 |
| CE-2 | 0.153 | 0.350 | 19 | 0.446 |
| CE-3 | 0.150 | 0.440 | 15 | 1.733 |

Part VI—Performance of Examples and Comparative Examples with Distilled H₂O and Pond H₂O

The Water Flux testing reported in Table 10 was conducted with an active area of 142 cm² under 50 psi with dead end flow at room temperature and results were reported as gallons/foot²/Day, i.e., 24 hours (G/F/D). The recovered filtrate was tested for turbidity in Nephelometric Turbidity Units (NTU) using a Hach Model 2100 AN Lab Turbidity meter. Color data reported as b* for the filtrate was determined using a Hunter Lab Ultra Scan US pro.

Examples 1 and 3C and CE-2 and CE-4, which was a 0.2 micron nitrocellulose filter obtained from Sterlitech, Corp., were compared. The pond H₂O used in the testing had a turbidity of 242 NTU and a percent transmittance of 76.1 and a b* of 8.00. The distilled H₂O had a turbidity of 0.33 NTU.

TABLE 10
Water Flux, Filtrate Turbidity and Color Properties of
Example 1 and CE-2 and CE-4

| | Distilled | Pond H₂O | | | |
|---|---|---|---|---|---|
| | H₂O | Water | Filtrate | | |
| Exam- | Water Flux | Flux | Turbidity | Filtrate % | Filtrate |
| ple # | (G/F/D) | (G/F/D) | (NTU) | Transmittance | b* |
| 1 | 1844 | 450 | 1.33 | 89.91 | 0.96 |
| 3C | 1544 | 545 | 0.98 | 91.2 | 0.98 |
| CE-2 | 1754 | 410 | 1.00 | 90.57 | 1.94 |
| CE-4 | 2108 | 527 | 1.01 | 89.5 | 3.06 |

An analysis of the metal ion content of the pond H₂O and the filtrate from Example 3C and CE-4 is included in Table 11.

TABLE 11
Metal Ion Analysis (ppm) of Pond Water and
Filtrate from Example 3C and CE-4

| Metal ion | | Filtrate of | Filtrate of |
|---|---|---|---|
| (ppm) | Pond H₂O | Ex. 3C | CE-4 |
| Al | 29.1 | 0.04 | 0.81 |
| Ba | 0.19 | 0.02 | 0.02 |
| Ca | 4.97 | 4.03 | 3.56 |
| Cr | 0.03 | <0.01 | <0.01 |
| Fe | 23.2 | <0.01 | 0.55 |
| K | 6.30 | 0.1 | 1.2 |
| Mg | 4.36 | 0.78 | 1.07 |
| Mn | 0.26 | 0.01 | 0.05 |
| Na | 1.66 | 7.47 | 1.78 |
| S | 3.71 | 5.99 | 3.94 |
| Si | 48.5 | 3.04 | 4.13 |
| Zn | 0.09 | <0.01 | 0.03 |

What is claimed is:

1. A microfiltration membrane comprising a microporous material, said microporous material comprising:
(a) a polyolefin matrix present in an amount of at least 2 percent by weight,
(b) finely divided, particulate, substantially water-insoluble silica filler distributed throughout said matrix, said filler constituting from about 10 percent to about 90 percent by weight of said microporous material substrate, wherein the weight ratio of filler to polyolefin is greater than 4:1, and
(c) at least 35 percent by volume of a network of interconnecting pores communicating throughout the microporous material; wherein said microporous material is prepared by the following steps:
(i) mixing the polyolefin matrix (a), silica (b), and a processing plasticizer until a substantially uniform mixture is obtained;
(ii) introducing the mixture, optionally with additional processing plasticizer, into a heated barrel of a screw extruder and extruding the mixture through a sheeting die to form a continuous sheet;
(iii) forwarding the continuous sheet formed by the die to a pair of heated calender rolls acting cooperatively to form continuous sheet of lesser thickness than the continuous sheet exiting from the die;
(iv) stretching the continuous sheet in at least one stretching direction above the elastic limit, wherein the stretching occurs during or immediately after step (ii) and/or step (iii) but prior to step (v);
(v) passing the stretched sheet to a first extraction zone where the processing plasticizer is substantially removed by extraction with an organic liquid;
(vi) passing the continuous sheet to a second extraction zone where residual organic extraction liquid is substantially removed by steam and/or water;
(vii) passing the continuous sheet through a dryer for substantial removal of residual water and remaining residual organic extraction liquid; and
(viii) optionally stretching the continuous sheet in at least one stretching direction above the elastic limit, wherein the stretching occurs during or immediately after step (v), step (vi), and/or step (vii); to form a microporous material.

2. The membrane of claim 1, wherein the polyolefin matrix comprises essentially linear ultrahigh molecular weight polyolefin which is essentially linear ultrahigh molecular weight polyethylene having an intrinsic viscosity of at least about 18 deciliters/gram, essentially linear ultrahigh molecular weight polypropylene having an intrinsic viscosity of at least about 6 deciliters/gram, or a mixture thereof

3. The membrane of claim 2 wherein the matrix further comprises high density polyethylene.

4. The membrane of claim 1 wherein the silica filler is rotary dried precipitated silica.

5. The membrane of claim 4 wherein the silica demonstrates a BET of 125 to 700 m²/g.

6. The membrane of claim 5 wherein the silica demonstrates a CTAB of 120 to 500 m²/g.

7. The membrane of claim 5 wherein the ratio of BET to CTAB is at least 1.0.

8. The membrane of claim 1 wherein the mean pore size ranges from 0.05 to 1.0 microns.

9. The membrane of claim 1 wherein the microporous material has a thickness ranging from 0.5 mil to 18 mil (12.7 to 457.2 microns).

10. The membrane of claim 1 wherein the microporous material demonstrates a bubble point of 10 to 80 psi based on ethanol.

11. The membrane of claim 1, wherein the microporous material further comprises (d) a coating applied to the surface of the microporous material.

12. The membrane of claim 11 wherein the coating applied to the surface of the microporous material is a hydrophilic coating.

13. The membrane of claim 1, wherein the silica (b) has been surface treated with at least one of polyethylene glycol, carboxybetaine, sulfobetaine and polymers thereof, mixed valence molecules, oligomers and polymers thereof, positively charged moieties, and negatively charged moieties.

14. The membrane of claim 1, wherein the silica (b) has been surface modified with functional groups.

15. The membrane of claim 1, further comprising a support layer to which the microporous material is adhered.

16. A method of separating suspended or dissolved materials from a fluid stream, comprising passing the stream through a microfiltration membrane comprising a microporous material, said microporous material comprising:
(a) a polyolefin matrix present in an amount of at least 2 percent by weight,
(b) finely divided, particulate, substantially water-insoluble silica filler distributed throughout said matrix, said filler constituting from about 10 percent to about 90 percent by weight of said microporous material substrate wherein the weight ratio of filler to polyolefin is greater than 4:1, and
(c) at least 35 percent by volume of a network of interconnecting pores communicating throughout the microporous material; wherein said microporous material is prepared by the following steps:
(i) mixing the polyolefin matrix (a), silica (b), and a processing plasticizer until a substantially uniform mixture is obtained;
(ii) introducing the mixture, optionally with additional processing plasticizer, into a heated barrel of a screw extruder and extruding the mixture through a sheeting die to form a continuous sheet;
(iii) forwarding the continuous sheet formed by the die to a pair of heated calender rolls acting cooperatively to form continuous sheet of lesser thickness than the continuous sheet exiting from the die;
(iv) stretching the continuous sheet in at least one stretching direction above the elastic limit, wherein the stretching occurs during or immediately after step (ii) and/or step (iii) but prior to step (v);
(v) passing the stretched sheet to a first extraction zone where the processing plasticizer is substantially removed by extraction with an organic liquid;
(vi) passing the continuous sheet to a second extraction zone where residual organic extraction liquid is substantially removed by steam and/or water;
(vii) passing the continuous sheet through a dryer for substantial removal of residual water and remaining residual organic extraction liquid; and
(viii) optionally stretching the continuous sheet in at least one stretching direction above the elastic limit, wherein the stretching occurs during or immediately after step (v), step (vi), and/or step (vii) to form a microporous material.

17. The method of claim 16, wherein the fluid stream is a liquid stream and is passed through the microfiltration membrane at a flux rate of 0.1 to 10 ml/(cm²×psi×min).

18. The method of claim 16, wherein the fluid stream is a gaseous stream and is passed through the microfiltration membrane at a flux rate of 0.2 to 2.0 ml/(cm²×psi×min)

19. The method of claim 16 wherein the silica filler is rotary dried precipitated silica.

20. The method of claim 19 wherein the silica demonstrates a BET of 125 to 700 m²/g.

21. The method of claim 20 wherein the silica demonstrates a CTAB of 120 to 500 m²/g.

22. The method of claim 20 wherein the ratio of BET to CTAB is at least 1.0.

23. The method of claim 16 wherein the mean pore size range from 0.05 to 1.0 microns.

24. The method of claim 16 wherein the microporous material has a thickness ranging from 0.5 mil to 18 mil (12.7 to 457.2 microns).

25. The method of claim 16 wherein the microporous material demonstrates a bubble point of 10 to 80 psi based on ethanol.

26. The method of claim 16, wherein the silica (b) has been surface modified with functional groups that react with or adsorb one or more materials in the fluid stream.

27. The method of claim 16, wherein the material to be separated from the fluid stream comprises heavy metals, hydrocarbons, oils, dyes, neurotoxins, pharmaceuticals, and/or pesticides.
